(19) United States
(12) Patent Application Publication
(10) Pub. No.: US 2010/0030776 A1
(43) Pub. Date: Feb. 4, 2010

(54) Method for taking automated inventory of assets and recognition of the same asset on multiple scans

(76) Inventors: Rajendra Bhagwatisingh Panwar, Mountain View, CA (US); Jonathan Robert Avrach, Menlo Park, CA (US)

Correspondence Address: RONALD CRAIG FISH, A LAW CORPORATION, PO BOX 820, LOS GATOS, CA, 95032, US

(21) Appl. No.: 12/587,162

(22) Filed: Oct. 2, 2009

Related U.S. Application Data
(62) Division of application No. 11/825,458, filed on Jul. 6, 2007.

(51) Int. Cl. G06F 17/30

(52) U.S. Cl. 707/5; 707/E17.071

(57) ABSTRACT

A computer system comprising a matching platform that has the capability to examine attributes from multiple scans on multiple attributes and determine which attributes from each scan pertain to the same attribute so the attribute is not counted twice. Extensible modules of weighted attribute matching rules can be plugged into the system which define the rules for matching based upon attributes. These modules define which attributes will be examined and the weighting of each in the matching process. The modules can contain different attributes and different weighting rules for different types of machines. With regard to weighting, when a match between attributes that are returned from two different scans occurs, the amount that match contributes toward the decision that the assets the attributes were collected from are the same asset depends upon the weighting of the particular attribute. Fuzzy snapshots and time-based reporting are possible. Matching is done on devices first, then elements installed on those devices such as software. Confidence metrics can be developed based upon the weights of matches. All matching is done against a set of attributes in the persistent data warehouse which comprise the complete set of attributes collected about a device or element from all previous scans.

### BRIEF DESCRIPTION OF THE DRAWINGS

FIG. 1, comprised of FIGS. 1A through 1C, is an overall big picture flow diagram showing the sequence of event of one embodiment of a system which can combine data from multiple local scans and import data from third party systems into one persistent global data warehouse data structure and then do matching on the attribute data in that data structure.

FIG. 2 is a flowchart of an embodiment of the process which is done each time a part of the data warehouse (local scan data tables formatted in the schema of the data warehouse) is received from any local scan, an illustrates the concept of snapshots. This process initially instantiates the tables in the persistent data warehouse and keeps them. updated with the latest attribute data and renders them ever more complete as new attribute data about existing devices is discovered in local scans or as new devices are discovered. The process of FIG. 2 also labels data put into the persistent data warehouse with snapshot IDs. Snapshot IDs inject an element of time of collection into the persistent data wareshouse collection of attribute data so that changes in inventory over time can be tracked and reported upon.

FIG. 3 is a diagram illustrating the data structure and processes of the persistent data warehouse object 78 and illustrating the data flows indicating how local scan attribute data is merged into the persistent data warehouse schema.

FIG. 4 is a diagram of the data warehouse schema which is established as an empty data schema in step 11 of FIG. 1A and the tables of which gets populated as the local and global scans are performed and the various matching processes of the flowchart of FIG. 2 are performed to match inventory assets between global scans.

FIG. 5 is a diagram that illustrates more detail about how the device matching process works and how attributes from local scans are accumulated and the device table attribute collection is rendered ever more complete as new attributes are found in successive local scans.

FIG. 6 shows how the result of the comparison of attribute data from scan S1 (118) and scan S2 (120) results in an intermediate result represented by S′ in the Persistent Global Device Table 88 and illustrates how the latest scan is always compare to an intermediate result consisting of the amalgamation of all the attributes found for that particular asset ID in all previous scans.

FIG. 7 is a flowchart that illustrates the process of using the highest weighted attributes to match first and then removing the attribute data of devices that have already been matched.

FIG. 8 is an example of a “device” and “element” matching process using the local scan tables of attributes and the persistent global data warehouse tables of attributes.

FIG. 9 is an example of one type of global persistent base table data structure.

FIG. 10 is an example of the data structure of the Persistent Global Ind-containment Table 92 in FIG. 3.

### DETAILED DESCRIPTION OF THE VARIOUS EMBODIMENTS

Getting an accurate automated count of assets in inventory owned or leased by an entity while not double counting assets is an important problem that all embodiments according to the teachings of the invention solve. Tracking changes in inventory over time is a very important part of the problem that some of the embodiments solve. Management is sometimes interested in knowing such things as: 1) what new software has been installed on the company computers during a certain period; 2) how many new machines were attached to the network of the company; 3) how many new servers were installed in the company data centers over some interval of interest; 4) how many servers and client computer had their operating system become obsolete or were upgraded during an interval of interest, etc.

A system according to the broadest embodiment is a matching platform. Such a system takes attribute data collected by automated asset inventory systems or imported from other systems in multiple scans and matches the attribute data from different scans. The system creates an inventory of assets of an organization from this process so that the same asset which returned different attributes on different scans does not get counted twice.

A system according to one embodiment is one or more software programs running on one or more general purpose computers and functions to provide an analytic store architecture which can process the attribute data collected about multiple assets of an organization over multiple local scans. The system can do matching of hardware assets such as computers and the software and installed “elements” such as other systems installed on the devices such as network cards, etc using attributes collected about each device and each element. For purposes of this patent, assets means all hardware and software assets discovered by one or more scans, “devices” means hardware assets, and “elements” means all software and other hardware assets installed on a “device”. In some embodiments, at least one of the computers does automated, agent-less discovery of the devices and elements to be inventoried and returns attribute data about each device and element so discovered. This automated inventory computer is coupled to the network or networks to which the assets to be automatically inventoried are coupled, and it does its discovery without the use of installed agents using collection scripts and fingerprint data files in the manner described in U.S. Pat. No. 6,988,134. In the preferred embodiment, the system that does the inventory is not included within the scope of the claims although the analytic store architecture software and data structures may be implemented (programs executed and data structures stored) on the same computer that does the automated inventory. The analytic store architecture system does matching on discovered attribute data stored in a data warehouse data structure. This attribute data can be automatically discovered by any automated inventory system which either does or does not use agents, and it can also be imported from other systems in an organization such as the accounting system of a corporation. The analytic store architecture has functionality to import all this attribute data, process it to put into the right format for matching, store it in a data warehouse data structure and the process the attribute data to match assets which have their attributes show up in different scans using the attribute data and weighting rules to make sure assets are not counted multiple times. Timestamp data on local scans is stored in the data warehouse. This provides functionality to provide a complete inventory and to track and correlate inventory assets over time and multiple scans.

Agentless discovery is known in the prior art and is provided by a software system which uses collection scripts to find attributes about assets connected to one or more networks to which the agentless discovery system is connected. A system according to the preferred embodiment does not require any intrusion into the assets to be discovered by installation of agent programs and it does not assign external persistent IDs to each asset that are required for matching. Matching, i.e., determining which assets detected in different scans are the same asset, is done strictly on attributes of the asset detected during the scan and weighting rules, and no reliance on persistent IDs assigned to assets by the matching system to do matching is necessary.

The preferred embodiments will use weighting rules for the various attributes to make matches between sets of overlapping attributes. The sets of overlapping attributes can be attributes returned on different scans or attributes returned on the most recent scan and a collective set of attributes collected about a machine. The collective set of attributes results from multiple previous scans and matches between these previous scans. When a match between attributes of a most recent scan and attributes of the collective set of attributes occurs, in one embodiment, any new attributes returned in the most recent scan are added to the comprehensive table of collected attributes found in previous scans such that the table becomes ever more complete over time. This table also contains an entry for any asset ever discovered during any scan at any time of any part of the entity, so it contains the overall picture of all assets the entity has ever had.

Essentially, a system according to the preferred embodiments is a matching platform that has the capability to examine attributes from multiple scans on multiple attributes and determine which attributes from each scan pertain to the same attribute so the attribute is not counted twice. In the preferred embodiment, modules can be plugged into the system which define the roles of which attributes get matched. These modules define which attributes will be examined and the weighting of each in the matching process. The modules can contain different attributes and different weighting rules for different types of machines.

With regard to weighting, when a match between attributes that are returned from two different scans occurs, the amount that match contributes toward the decision that the assets the attributes were collected from are the same asset depends upon the weighting of the particular attribute. Some attribute matches count much more than others in the matching process. The attributes that count the most are the attributes which are the least likely to vary from one scan to the next when collected from the same machine. These type attributes tend to be weighted heavily. For example, the IP address carries very little weight because if a machine gets its IP address from a DHCP server, the IP address can change during every online session. On the other hand, the motherboard serial number will carry a heavy weighting since the motherboards on machines are not frequently replaced.

A system according to all embodiments will be able to recognize that an item is the same asset as previously discovered even though on different scans, different subsets of the attributes of the asset will be returned. For example, on one scan, a serial number might be returned along with other attributes like the MAC address and the hard drive size. On another scan, the serial number will not be available, but a BIOS identity will be returned which was previously returned along with other attributes returned on the scan which correspond to attributes returned on the first scan. On another scan, the MAC address of the network card is returned along with some other attributes, but the serial number is again not returned. Using weighting rules for each of these attributes, matches can be made based upon matches of partial sets of attributes. Some attributes are weighted more heavily than others since they are less likely to change from one scan to the next, so matches in these attributes are highly indicative that a machine which showed up on two different scans with different but somewhat overlapping attributes is the same machine.

A system according to the most preferred embodiments will be able to create a data structure which enables tracking changes in inventory over time and changes in any particular asset over time as parts or software are replaced or upgraded. A system according to all embodiments will be able to generate a data structure from inventory data which allows matching not only of machines such as servers, client computers, etc. but also of the software that is installed on those machines, and other subsystems within the machines. A system according to some embodiments will generate a data structure which will support generation of reports of current assets as well as reports of all assets an entity has ever had. Although in the preferred embodiment, multiple tables are used in the data warehouse, and the data from each global scan is kept in its own table as is the data from each local scan, in other embodiments, all the data from all the global scans and local scans can be merged into one big table or fewer tables than are used in the preferred embodiment. In the preferred embodiment, the base table is the most important table for matching, and it has both hardware and software elements commingled in it. However, in other embodiments, the hardware assets can be segregated from the software assets.

The functionality provided by the system of some embodiments provides a mechanism to combine information available from a plurality of smaller scans of parts of an enterprise and combine that information into a data warehouse which enables management to get one global picture of all the assets a company has. A persistent database schema (the data warehouse) keeps accumulating attributes of assets and assets that show up in one scan but not others so as to provide the global picture of a cumulative inventory. The cumulative inventory is a list of all the assets that have showed up in any of the previous scans.

A system according to some embodiments will accumulate attribute data of assets it discovers on any scan, i.e., from multiple scans taken at different times and/or in different locations, in the data warehouse so as to provide a cumulative picture of all the assets which have ever been in the inventory of a company. Some embodiments automatically remove assets from the data warehouse after a predetermined number of scans in which they do not show up.

In other words, the functionality provided by some embodiments provides a mechanism to combine data from different scans conducted at different times and/or different parts of the entity for the same set of elements, and an ability to recognize elements from one scan to the next via the attributes of each device or element turned up by each scan and weighting rules. The system provides a data structure called the data warehouse which is the table or set of tables (or any other suitable data structure) which contains an entry for every asset ever discovered during any scan and a comprehensive set of attributes collected about that asset. Timestamps are included in the entries in many embodiments to provide timeline information on assets. However, the local scan data for each local scan is compartmentalized into its own address space in the preferred embodiment, and each address space has with metadata that indicates the date and usually the time of the scan. When the data from a local scan is merged into the cumulative inventory file generated from previous global scans, this timestamp data goes with it. A cumulative inventory file is a catalog of all assets ever found on any global scan. A global scan is executed by running several local scans taken at possibly different times and in possibly different areas of a large enterprise. This cumulative inventory file or catalog of all the assets of an entity and their attributes grows and becomes more complete over time and provides the basis for data mining to generate reports that indicate how the catalog of assets has changed over time or how the assets themselves have changed over time.

A system according to some embodiments also has the ability to import attribute data about assets discovered by agent-based discovery systems such as the Tivoli system from IBM, and to format the data into the proper format for attribute data of the type stored in a data warehouse and store the properly formatted attribute data in the data warehouse along with the attribute data discovered by the agentless automated inventory system.

In the preferred embodiment, assets are just accumulated and not removed by the system from the data warehouse when they are retired or destroyed. In other embodiments, additional functionality is present which counts the number of scans upon which an asset which was detected once but does not show up when it should show up. After a predetermined number of scans where the asset should have shown up but did not, the asset is added to a list of possibly missing or destroyed assets for managers to deal with in whatever way is appropriate.

A very aggressive matching approach is used in the preferred embodiment such that matches on even one highly weighted attribute, e.g., domain name, which showed up on two different scans is enough to cause a match to be declared. This ability to match assets that show up in different scans allows time-based comparisons across multiple scans to see how an entity's inventory is changing over time. The system according to some embodiments also allows data collected by other agent-free or agent-based automated asset discovery systems such as Tivoli to be assimilated into the inventory data structure of a data warehouse.

A global scan combines data from one or more local scans. Global scans are typically done on a periodic basis such as every month. Each global scan represents the state of inventory of the entire enterprise at one particular “moment in time”. Actually the “moment in time” of each global scan is not an exact moment in time but is what will be referred to herein as a “fuzzy snapshot”. A fuzzy snapshot allows time-based reports to be generated. A fuzzy snapshot combines asset data sets from different collection data sources, different regions and different times into a pre-defined window which is defined as the time of the report. If one thinks of the asset data as a three dimensional space of time, region and source, the fuzzy snapshot represents a three dimensional volume in that space that represents all sources, all or some of the regions and a range of time.

All embodiments which include the automatic inventory steps and the computer equipment and software to do this automated inventory do away with this problem of needing to install an agent program on each asset which is to be discoverable. But development of a technology for recognition of the same asset in different scans when every scan does not return the same subset of attributes of the asset is the price that must be paid to achieve this advantage. Use of weighting rules to match attributes from different scans is another characteristics of the genus. A sub-genus is characterized by the fact all species therein will have the ability to take automated discovery without installed agents to find the attributes of devices on the networks of an entity.

A system according to another embodiment itself will take agentless discovery to do automated inventory and the system then does matching on discovered attribute data stored in a data warehouse data structure to match assets which have their attributes show up in different scans using the attribute data and weighting rules. Agentless discovery systems are known in the prior art. Once such system is disclosed in U.S. Pat. No. 6,988,134 owned by the assignee of the present patent application. Another agentless discovery system is owned by IBM and is disclosed in their Red Books. This system allegedly only can discover large assets such as servers and cannot discover assets like printers, laptops, routers, VOIP phones etc. No further information is available about the agentless IBM inventory system at this time.

A system according to the preferred embodiment also has the ability to store attribute data discovered about assets in a data warehouse data structure using an agentless automated asset discovery system and analyze that attribute data using weighted matching rules for purposes of matching of assets and tracking of inventory changes over time. This data warehouse and the system to analyze its entries provides functionality to provide a complete inventory of any asset a company has ever had, to track inventory changes over time and to correlate inventory assets over time and multiple scans to prevent double counting of assets.

### Extensible Weighting Rules

The set of weighting rules based upon attributes used to do the recognition and matching judgments by the system are extensible. This means in all embodiments that rules can be added and this can be done either by removing the rule set and substituting in a new rule set with new rules, or by simply adding new rules to the existing set. In some embodiments, the “extensible” nature of the rule set also means that as new asset types are added to the environment being scanned, new weighting rules for matching on attributes can be devised and added or already existing matching rules can be modified to match the new type of asset based upon its attributes. In some embodiments, one extensible set of weighting rules is plugged in and used to do matching for all assets found on a scan. In other embodiments, a different extensible set of weighting rules is used to do matching on each different type of asset. In both these classes of embodiments, the sets of weighting rules can be contained in modules. These modules define which attributes will be examined and the weighting of each in the matching process. The modules can contain different attributes and different weighting rules for different types of machines. The rules and weighting for an IBM server might be different than the rules and weighting for a Sun server, and the rules and weighting for an IP phone will be different than the rules and weighting for a Cisco router. In some embodiments, when a scan returns attributes indicative of the fact that the underlying asset is a server or some particular type of server, then the system of this embodiment retrieves or accesses a set of matching rules “tuned” to be efficient in finding matches for servers or for this particular type of server. When the set of attributes returned by a scan indicates that the underlying asset may be a Voice over IP phone, then a set of weighting rules “tuned” to efficiently finding matches for IP phones is retrieved or accessed and used. The term “extensible” in the claims should be interpreted to cover all these different embodiments.

The weighting of attributes depends upon their significance in the matching process. The host name and IP address are the two most important attributes which will almost always show up on any scan so they are weighted heavily.

Use of matching rules to match assets from different scans allows time-based comparisons across multiple scans to see how an entity's inventory is changing over time. The system of some embodiments also allows data collected by other sources such as Tivoli to be assimilated into the inventory data structure of a data warehouse. The functionality provided by the system of the invention also provides a mechanism to combine information available from a plurality of smaller scans of parts of an enterprise and combine that information to get one global picture of all the assets a company has. A persistent database schema keeps accumulating attributes of assets and assets that show up in one scan but not others so as to provide the global picture of a cumulative inventory comprising a list of all the assets that have showed up in any of the previous scans and all the attributes that have been collected about those assets. Enterprises are very fluid, especially ones that have big Information Technology budgets.

In the preferred embodiment, assets are just accumulated and not removed by the system when they are retired or destroyed. In other embodiments, additional functionality is present which counts the number of scans upon which an asset which was detected once but does not show up when it should show up. After a predetermined number of scans, the asset is added to a list of possibly missing or destroyed assets for managers to deal with in whatever way is appropriate.

### Example of One Embodiment that Combines Data from Multiple Scans an Integrates Attribute Data from Third Party Inventory Systems and Matches Based Upon Attributes

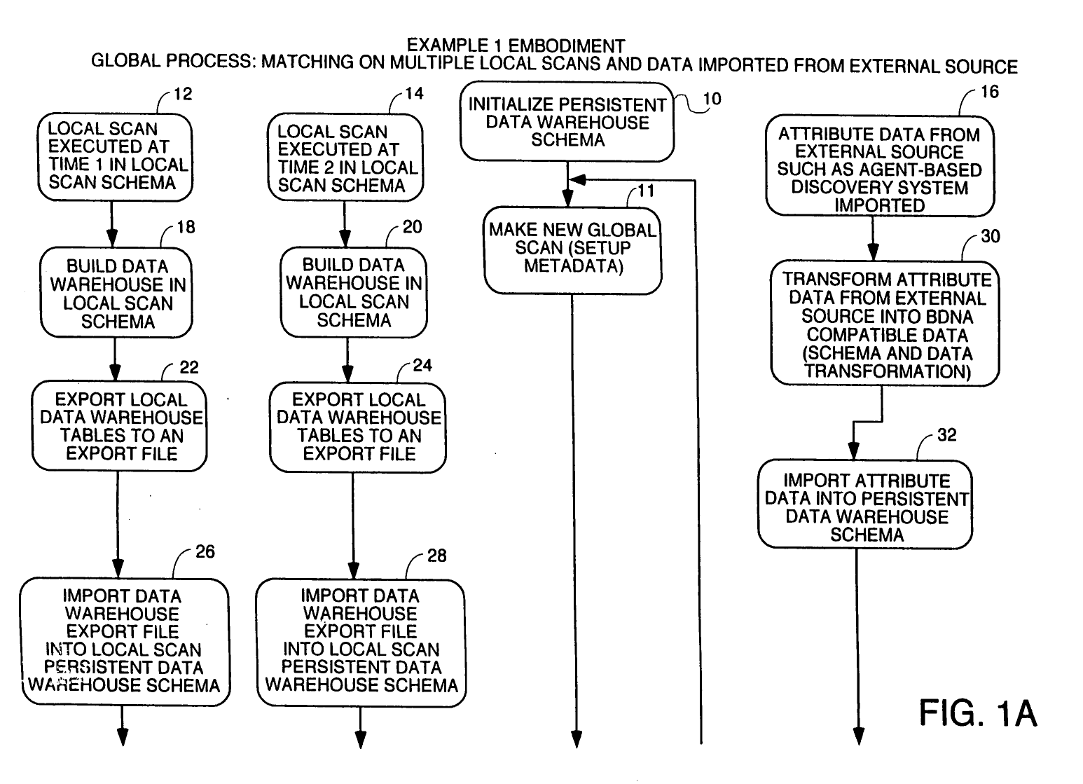

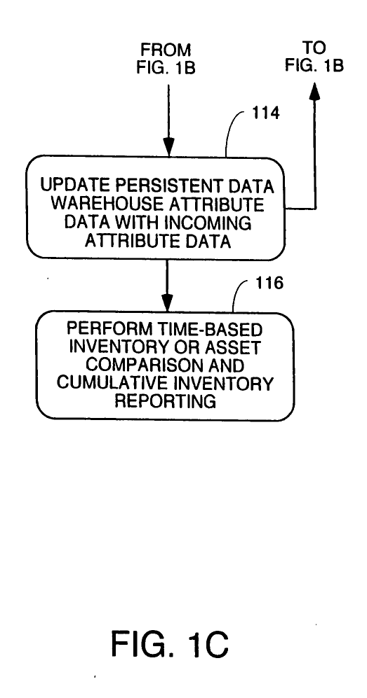

FIG. 1, comprised of FIGS. 1A through 1C, is an overall big picture flow diagram showing the sequence of event of one embodiment of a system which can combine data from multiple local scans and import data from third party systems into one persistent global data warehouse data structure and then do matching on the attribute data in that data structure. Step 10 represents the process of initializing a persistent global data warehouse data structure also sometimes called a schema herein. Typically, this persistent global data warehouse schema comprises a plurality of tables, and step 10 sets up these tables as a framework data structure to be populated. In FIG. 3, the persistent global data warehouse data structure is comprised of data structure 34A which stores the persistent global device table 88, a persistent global base table 90 and a persistent global indirect containment table 92. One of these data structures 34A is set up for each global scan. Step 10 sets up empty versions of these tables for each new global scan. Step 10 also sets up empty versions of the same type tables as the local scan data warehouse 34B each time a new local scan is performed so that the attribute data collected in each local scan which is part of a global scan can be compared in the device matching and element matching processes to the attribute data in the persistent global data warehouse data structure to find matches. Finding a match means using the attribute data collected from a device or an element in a local scan to compare to attribute data collected from devices and elements on previous scans and stored in said persistent global data warehouse to determine which devices or elements which returned the attribute data on the local scan are the same devices or elements having attribute data already stored in the persistent global data warehouse so that the same asset device or element is not counted twice. Matching is done based upon attributes using weighted attribute matching rules. In other words, the data structure which is set up for each of the data structures 34A and 34B comprises a plurality of empty tables with the semantics of the fields (names and meanings) and the definitions of the data types to be entered in each field set up.

The particulars of the data schema are not important to the invention and it can be fairly complex with tables representing containment relationships and whatever else is useful in collecting and storing attributes of many different types of assets of an enterprise class entity.

Tables are not the only type of data structure which will work for the data warehouse. Relational or regular databases may also be used.

The tables of the data warehouse are populated with attribute data that is discovered in one or more local scans represented by blocks 12 and 14 and/or by attribute data imported from another external source such an agent-based automated asset discovery system, as represented by the line of blocks starting with block 16. Each of local scans 12 and 14 represents an agentless scan taken using the system disclosed in U.S. Pat. No. 6,988,134, in the preferred embodiment. In alternative embodiments, the local scans 12 and 14 may be implemented by other agentless automated inventory systems available in the prior art, if any.

The agentless scans are not part of the invention in the broadest formulation thereof, but are part of an overall system definition of the invention. The broadest formulation of the invention is a matching platform that uses an extensible set of rules and weighting functions to do matching between attribute data returned from multiple scans to determine which attribute data in different scans was derived from the same underlying asset.

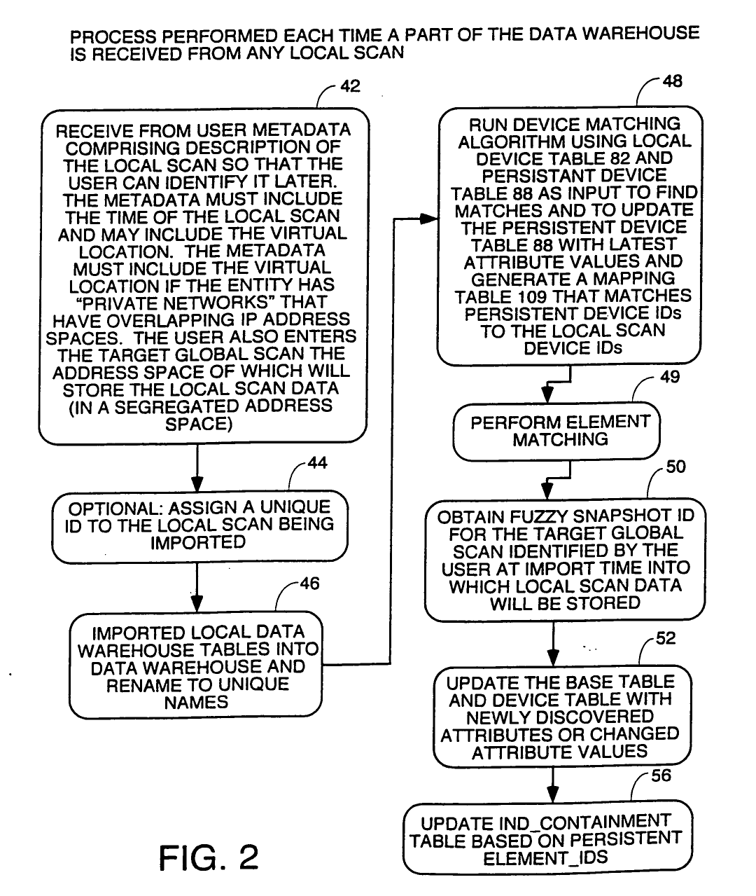

Each local scan is one of the local scans represented by arrows 58, 60 and 62 in FIG. 3 and by the line of steps starting with steps 12 and 14 in FIG. 1A. Each of the local scans such as 108 and 110 in FIG. 4 are executed independently of each other and can be taken together at different times. The local scans can also be taken at different frequency, and the data from a scan may not be available right away at the time the scan is taken such as in a situation where a scan is taken of the IT environment of a cruise ship while at sea. The user can specify if particular local scan data is to be re-used in a global scan. Devices in a local scan may be different from one global scan to the next because of a different partition on the later global scan.

Each local scan is taken at one time and possibly only covers one portion of a company. For example, an entity like General Motors or the United States Navy may have operations all over the United States or the world, each having its own collection of assets and each having its own network. A local scan may be of only the assets connected to the network of one operation in, for example, Flint, Michigan. Other scans taken at the same time or later times may cover the assets coupled to the networks in other locations, such that the collection of all the scans covers the assets of the entire company or entity. Some of the scans, represented by block 16, may be done using third party software that does agent-based discovery such as the Tivoli system from IBM or the data may be extracted from already existing computer systems in the company such as the shipping and receiving system, accounts payable system or the legacy computer systems used by the financial arm of the company to do the financial reporting of the company. This external data entering the system by the process represented by block 16 could come in through a spreadsheet or other manual sources such as a data entry terminal.

It is desirable to consolidate all the attribute data collected from the local scans such as 12 and 14 and the attribute data collected from external sources such as third party agent-based discovery systems in one place and in one data format. That is the purpose of the persistent data warehouse schema, i.e., to collect all the data from all the scans of all the different parts of the company taken by both agent-less discovery tools and collected from external sources, and store it in one place in one universal data format. It is also desirable to collect all the local scan attribute data from a plurality of local scans that cover an entire entity into one global scan. That is the purpose of step 11. Step 11 is performed after the device matching process of step 114 to make a new global scan table like table 102 in FIG. 4 and to instantiate it with local scan tables that together comprise one global scan. In other words, step 11 sets up a global scan table, sets up its metadata that gives it its global scan ID and other information, and instantiates the global scan table with one table for each local scan which together comprises the global scan.

Returning to the consideration of FIG. 1A, the attribute data from each local scan and each external source needs to be processed and exported from the system in which it was collected and imported into the data warehouse. Steps 12 and 14 represent the process carried out in U.S. Pat. No. 6,988,134 or some other equivalent process of building a data warehouse in the semantics and data types of the local scan schema. These steps 12 and 14 represent collecting scan data from local scans into a single database schema called a transactional data store. The data stores built by steps 12 and 14 are constantly being updated and data is being deleted.

In steps 18 and 20, the local scan data is normalized which means that the detailed discovery data strings from the same element or device, which may have changed slightly from one local scan to the next, is converted to a standardized format which makes it easier to match two discovery strings which are different but which are from the same device or element. For example, one local scan may return a string for Oracle “10.2.3.0.1” and the next local scan may return a string for the same application of “10.2.3.0.2”. These two strings would be normalized to “10.2” because they are from the same element. Then, steps 18 and 20 convert the transactional data into a data warehouse in the local scan schema for each local scan. This process transforms the detailed scan data into data that has been reformatted and packaged differently to conform to the data warehouse structure. This data warehouse data is more efficient to process.

Steps 22 and 24 represent exporting the local scan schema data to an export file, which is any flat or binary file suitable for importing into the global data warehouse data schema.

Theoretically, the local transaction data could be used in the data warehouse for asset matching without transformation to the data warehouse schema, but performance would lag. During discovery, much raw data is collected. This raw transactional data includes a large amount of “inactive” data which has been discarded because better, more-recent data has come in.

The process of blocks 12, 18 and 22 and the process of 14, 20 and 24 will be performed as many times as there are local scans. Note that block 12 represents a local scan at time one, and block 14 represents a scan at time 2. Each time the process of block 22 or 24 is performed, the persistent data warehouse expands the number of tables it keeps to accommodate the new local scan data. The data exported from each local scan goes into a separate table or memory area of the data warehouse so that it does not get commingled with the other data. This way, if a local scan is bad or results in corrupted data, the rest of the data in the data warehouse does not get corrupted. If local scan data is corrupted and gets exported into the data warehouse, the table containing it can be removed.

Steps 26 and 28 represent the process of importing the data from the local scans 12 and 14 from the exported files created in steps 22 and 24 into the local scan persistent data warehouse schema 34B in FIG. 3. For efficiency in matching, after this importing of steps 26 and 28, a “local device table” (82 in local scan data structure 34B) is built from the detailed scan data. That process of building a local device table from the local scan data is represented by steps 27 and 29 in FIG. 1B for each of two different local scans. A device table is a collection of key attributes about each device. These key attributes are generally the most important attributes needed to match the same device from different scans. The device table is built by filtering out unwanted or unimportant attributes from the data warehouse's complicated data structure. There is a “global” device table (88 in FIG. 3) in the persistent data warehouse 34A in FIG. 3, and a “local scan” device table 82 in each local scan data warehouse (34B in FIG. 3). Building the local scan device table makes matching faster and more efficient, but is not necessary in all embodiments. In most embodiments, steps 27 and 29 are performed after importing the local scan data to build the device table. In some embodiments, steps 26 and 28 do both the importation of the local scan data as well as the process of building the device table.

Both the global (persistent) data warehouse (34A in FIG. 3) and the local scan data warehouse (34B in FIG. 3) contains a base table (represented by table 90 in the persistent data warehouse and 84 in the local scan data warehouse). The base table contains attribute data of all inventory assets (devices and software installed on them). The local scan base table only contains all assets discoved on one local scan. The matching process of FIG. 3 is a process to determine which assets discovered on the local scan are the same assets as are already in the base table 90 of the persistent data warehouse.

There is also an indirect containment table in both the persistent data warehouse and the local scan data warehouse (tables 92 and 86, respectively). The containment tables shows how various assets in the base tables are related to other assets in the base tables.

Block 34 represents the process of instantiating the fields in the local scan device table 82, the base table 84 and the indirect containment table 86 in the local scan data structure 34B in FIG. 3. In some embodiments, this process is automatic and in other embodiment, the user does this process manually. The local scan data warehouse 34B contains a device table, a base table and individual containment tables for the data from each local scan in the preferred embodiment, these tables from one local scan being represented by tables 82, 84 and 86. In the preferred embodiment, the attribute data from each local scan is stored in a separate namespace or address space in either volatile or non-volatile memory of the automated inventory system so that is it not commingled, as represented by process 72 in FIG. 3. Likewise, attribute data received from an external source is stored in a separate namespace in either volatile or non-volatile memory in the automated inventory system with data from each different external source stored in a different namespace. This allows data from a particular scan to be removed if, for example, it is corrupted or to be replaced with updated scan data if, for example, something went wrong in the process of converting the data to the data schema of the persistent data warehouse store 34, exporting it and importing it or if the scan was corrupted because the entity firewalls blocked the scan probe packets on a particular day. The original attribute data colleted during the scan still exists on the system that performed the scan so the conversion, exporting and importing process can be carried out again if something went wrong the first time and the attribute data resulting from this second attempt can be stored in the data warehouse store 34 in the place of the data from the scan that got corrupted somewhere in the import process.

Returning to the consideration of FIG. 1, attribute data from third party software such as agent-based discovery systems or imported from legacy systems is imported in step 16. That imported data from external systems is transformed in step 30 into BDNA compatible attribute data. This means attribute data having different labels (semantic meaning of the data) in the third party systems but meaning the same thing as data in some particular field of the persistent data warehouse is labeled with the proper name (semantics) used for that type of data in the persistent data warehouse and, if necessary, is converted to the proper data type for data of that name in the persistent data warehouse (hereafter referred to as the data warehouse). Thus, floating point attribute data giving hard drive capacity in gigabytes from an agent-based external source and named “nonvolatile memory capacity” may be converted to integer data in the form of megabytes and given the name “hard drive capacity” to make it compatible with the data warehouse semantics and data type defined for the “hard drive capacity” attribute.

Step 32 represents the process of importing the processed data from the external source into the data warehouse. The data warehouse data structure has its fields at least partially instantiated with attribute data collected from the local scans and from external sources is represented by block 34.

### The Device Matching Process

Step 100 in FIG. 1B represents the device matching process of block 94 of FIG. 3. Generally, “devices” as used herein means hardware, and “element” means software or other subsystems installed on a particular device. This process matches hardware devices found in the local scans using their attributes to devices already recorded in the persistent data warehouse schema. Weighted matching rules from extensible matching rule sets are used to do the matching. More discussion on this will be found later herein. The matching rules compare attribute data in the local scans of the various global scans in FIG. 4 to each other and determine which hardware assets in each global scan are the same asset as hardware devices found in other global scans. In some embodiments, the device matching process uses modules of extensible, weighted matching rules to match incoming inventory attribute data from the local scans with the persistent data warehouse inventory attribute data. For example, there may be separate modules of matching rules for Solaris operating systems, Oracle database application, Linux servers etc. Having the matching rules broken into modules makes the matching rule set easier to maintain and use and easier to deploy such as by shipping a new set of rules to a user.

### Modules of Matching Rules and Calling Up the Appropriate Module

The matching rules are extensible and can be organized in modules which are called into the matching process as needed. In some embodiments, the matching rules in various modules are organized by the type of device or element whose attributes are being examined. For example, in some embodiments, if the attributes returned by a local scan that are being compared to attributes returned in previous scans indicate the device which returned the attributes is a server or a voice-over-IP phone, the appropriate set of weighted matching rules for a server or voice-over-IP phone are called up for use in the matching process. In other embodiments, other organizations for the matching rules modules may be used such as including all matching rules in one module and calling the latest incarnation of that module up during the matching process to make sure the latest set of rules is being used since new rules may be added at any time and old rules that are causing errors can be deleted at any time.

The matching rules are used to compare device attribute data in the local scan (from, for example, table 82 in FIG. 3) to attribute data of the various global scans in the global scan tables like 102, 104 and 106 in FIG. 4. This matching process uses matches between weighted attributes in the local scan data in the local scan table 82 in FIG. 3 and the global scan data in the Persistent Global Device Table 88 in FIG. 3 to draw conclusions as to which device assets in a particular local scan of a global scan are the same device assets found in previous global scans (if any because new hardware devices get added from time to time so for a new device there would be no previous device matching it in any previous global scan).

In FIG. 4, each of the global scans contains data regarding the assets of the entire entity being inventoried. Each global scan is comprised of a plurality of local scans, each of which is stored in its own address space to avoid corruption of the global scan in case of a corrupted local scan. The local scans generally are non overlapping in terms of the IP address space that they cover, but it is not essential that each local scan be of a non overlapping portion of the overall address space of the entity. This is because if there is overlap between the IP addresses covered by the two different local scans, the assets in the overlapping IP spaces will be reported in each local scan, but the matching process will sort that problem out, and the asset will not be counted twice.

### The Element Matching Process

On each device there may be installed software applications, network cards, multiple hard drives, Zip or Firewire internal or external drives, etc. which also need to be inventoried. This is the function of block 112 in FIG. 1B. The process symbolized by block 112 is the element matching process. This process uses an extensible set of weighting rules to match incoming inventory attribute data with persistent inventory attribute data in the data warehouse. The process of block 112 finds out which elements such as software applications are installed on each device. The device matching first followed by element matching sequence is preferred because if software matching is done first, the most important attribute about the software, i.e., on which device it is installed, is missing. If this attribute about a piece of software is missing, it is difficult to distinguish how many different copies of that software exist in an entity. Knowing on which device each piece of software is installed makes it possible to better distinguish and accurately count the number of software titles that are owned or leased by an enterprise.

### Mapping Table and Cumulative Inventory Table

When a match is found, the mapping table (109 in FIGS. 3 and 4) is updated to show which device in a particular local scan of a particular global scan corresponds to the same device in another global scan. Also, when a match is found, the cumulative inventory table 111 is checked in some embodiments to make sure the device is in the cumulative inventory table. The cumulative inventory table 111 in FIG. 4 is called the Persistent Global Device Table 88 in the embodiment of FIG. 3. If not, the cumulative inventory table or Persistent Global Device Table 88 is updated by adding the device all all of its attributes. In other words, all the hardware attributes about each device such as the IP address, what kind of network interface card the device has, the hard drive capacity, etc. are stored in the cumulative inventory information table 111 (Persistent Global Device Table 88) also, and as new attributes are found regarding the same device, those attributes are added to the collection of attributes stored in these tables for this device. These are the functions that are represented by block 114 in FIG. 1C.

Step 116 represents the optional process of receiving a user input command to do a time-based report or asset comparison report or cumulative inventory report. A time-based report is a report on the changes in an inventory asset over time or changes in the cumulative inventory over time.

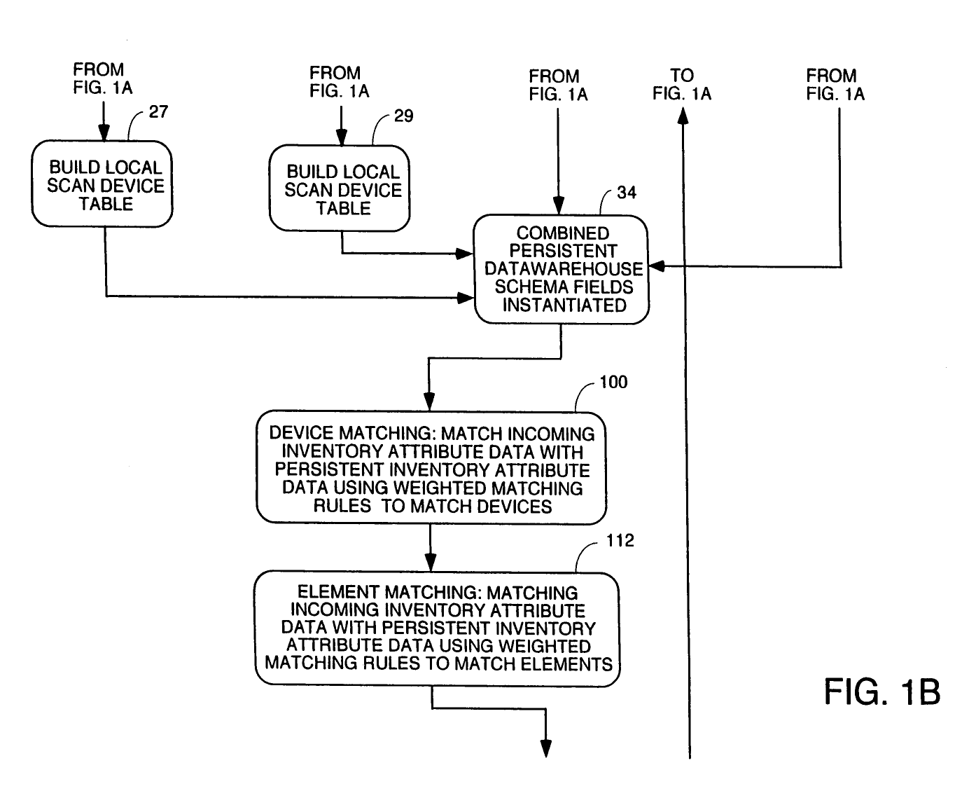

### FIG. 2

FIG. 2 is a flowchart of an embodiment of the process which is done each time a part of the data warehouse (local scan data tables formatted in the schema of the data warehouse) is received from any local scan, and illustrates the concept of snapshots. This process initially instantiates the tables in the persistent data warehouse and keeps them updated with the latest attribute data and renders them ever more complete as new attribute data about existing devices is discovered in local scans or as new devices are discovered. The process of FIG. 2 also labels data put into the persistent data warehouse with snapshot IDs. Snapshot IDs inject a dimension of time of collection into the persistent data warehouse collection of attribute data so that changes in inventory over time can be tracked and reported upon.

In embodiments where the importation of local scan data is done, the following steps are done in the embodiment represented by FIG. 2 each time a part of the data warehouse (local scan data tables formatted in the schema of the data warehouse) is received from any local scan.

### FIG. 2 Local Scan Matching Process Embodiment Using Metadata and Fuzzy Snapshot IDs

The process of FIG. 2 represents a different embodiment than the matching process represented by FIG. 3 because there is no notion of metadata or fuzzy snapshots in the matching process of FIG. 3. The basic difference between the matching processes of FIG. 2 and FIG. 3 is that in the embodiment of FIG. 3 will result in an inventory which cannot be time differentiated. It will be an inventory which represents every asset which has ever been discovered even if it is not still in service. The embodiment of FIG. 2 has the notions of metadata and fuzzy snapshots. The metadata includes at least time of collection information so that assets can be tracked over time. It also includes virtual location metadata in some embodiments with the genus of FIG. 2 which allows reporting based upon geographical location of assets. The fuzzy snapshot notion of FIG. 2 allows reporting how assets changed over time in the sense that the inventory of assets during some range of times of local scans and some range of virtual locations can be compared to the inventory of assets at a different range of times and virtual locations.

Step 42 represents the process of receiving metadata from the user which describes the local scan data being imported so that this data can be labeled in the data warehouse such as by labeling the table into which it is imported. This user defined metadata or “label” data helps differentiate the local scan data from different local scans. The metadata must include the time of the local scan. This time establishes the global scan of which the local scan will be a part. In FIG. 4, note that multiple global scans are depicted such as 102, 104 and 106.

The metadata assigned by the user to each local scan can include “virtual location”. The metadata assigned by the user must include a virtual location if the entity being inventoried includes “private networks” which have overlapping IP address spaces such as can occur when each of a plurality of local area networks are coupled via a network address translation gateway to a wide area network. In such a case, the IP address behind the NAT gateway can overlap but be assigned to different assets. In such a case, the virtual location is necessary in the metadata to prevent two different assets coupled to the same IP address from being counted as only one asset. A “virtual location” is metadata which is analogous to a geographic location, but is actually a subset of the IP address spaces of the entity being inventoried. When two or more different assets have the same IP address but different virtual locations, they will not be counted by the matching process as only one asset.

Each global scan is comprised of a plurality of local scans, each of which has its own metadata. The local scans within each global scan can be taken over a range of times and from different virtual locations.

Each local scan data is kept in its own space in the address space of a global scan of which it is a part, as illustrated in FIG. 4. The user supplies the following information, in no particular order. First, the user enters a description of the local scan data to be used in labeling the table in which it is stored. This allows the user to identify the scan data later. An example might be, “Hawaii scan from January 2006”. Next, the user enters the virtual location, e.g., North America. Finally, the Target Global Scan is entered, e.g., the “global scan from January 2006”. The Target Global Scan in the global scan table in the persistent data warehouse into which the local scan data is to be stored in its own table, as shown for example at 108 in FIG. 4. A “virtual location” is

Step 44 represents the optional process of assigning a unique ID such as the NNN to the local scan being imported. Assigning a unique ID to each local scan and keeping the local scan data in its own address space allows that local scan data to be located again later and eliminated if it is corrupted so that it does not corrupt the entire global scan. In the broadest embodiments, this step is not necessary since it is assumed that no local scan data will be corrupted.

Step 46 represents the process of blocks 26 and 28 in FIG. 1B of importing the local data warehouse tables prepared in steps 22 and 24 into the appropriate local scan tables 34B (shown in FIG. 3) and renaming them to unique names to prevent name conflicts between the base table, indirect-containment table and the device table in the persistent global data warehouse data structure and the local data warehouse data structure containing the same types of tables. This process is represented by the data flow arrows 76 and 74 in FIG. 3. The device table 82, base table 84 and ind_containment table 86 in FIG. 3, when instantiated with data from a particular local scan, need to be renamed to unique names in a namespace assigned to that local scan. An example for local scan NNN would be device table-NNN, base table-NNN, etc. Since each local scan is assigned a unique ID, that unique ID can be appended to the individual table names. This is the process that prevents commingling of possibly corrupted local scan data into the data in the persistent tables 34A in FIG. 3.

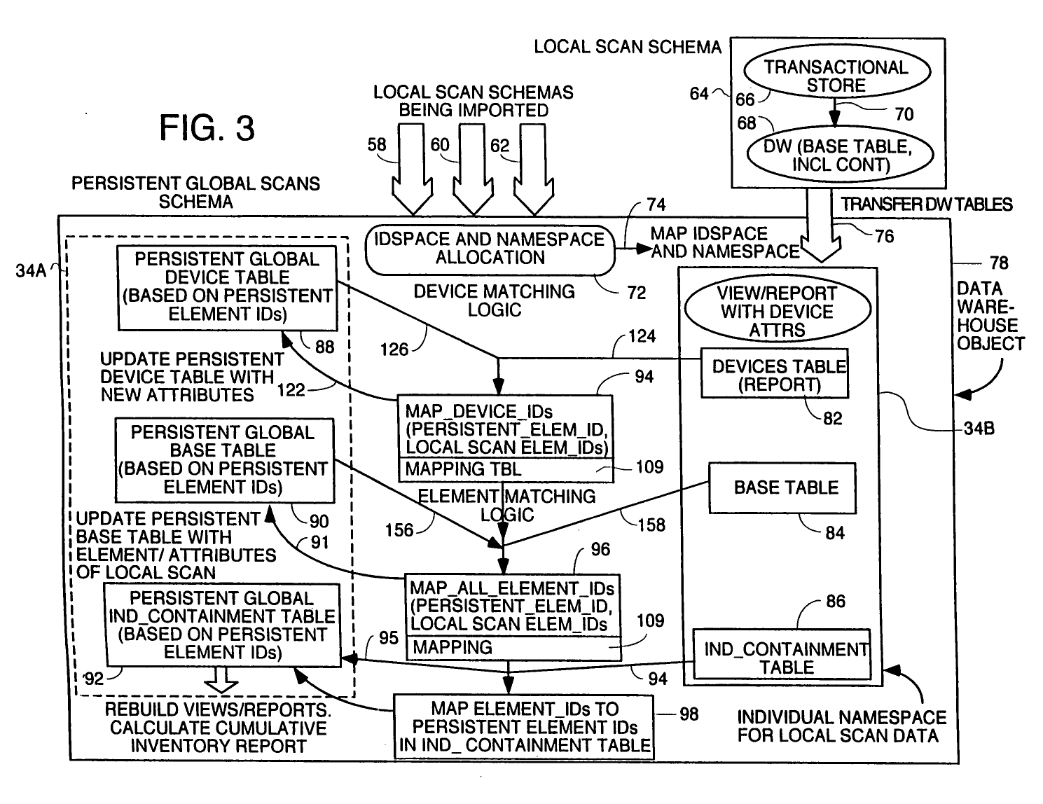

Step 48 represents the process of running the device matching algorithm using the local scan device table (82 in FIG. 3) just imported and the persistent data warehouse device table (88 in FIG. 3) as inputs. This operation finds matches between the devices in the persistent device table and the local scan device table using the matching process of FIG. 5. This process also updates the persistent data warehouse device table 88 with the latest discovered attribute values imported from the local scan so that if an attribute of a device changes from one local scan to the next, the latest attribute value will be written into the persistent device table 88. The process of step 48 also generates a mapping table 109 in FIG. 3 which matches persistent device table IDs to the local scan device IDs. Every asset has a unique ID. The same device in the persistent device table and the local scan device table will have different IDs until they are matched. After matching, the persistent device table ID will be used.

In this matching algorithm, weighting rules are used to compare attribute data from the local scan attribute data to attribute data in the persistent data warehouse data table (hereafter referred to as just the persistent device table) using the process of FIG. 5.

Step 49 represents the element matching process of block 96 in FIG. 3. This matching process matches installed software and hardware subsystems on various ones of the devices matched in step 48 to make sure that the same elements are not counted twice. The matching is done using weighted attribute matching rules in the manner described in FIG. 5.

Step 50 represents the process of obtaining a snapshot ID for the target global scan using the user specified target global scan ID. Each global scan such as 102, 104 and 106 in FIG. 4 can cover a range of times and a range of virtual locations. This range of times and virtual locations is called a “fuzzy snapshot” and is assigned a unique snapshot ID.

Step 52 represents the process of updating the persistent base table and persistent device table with any newly discovered attribute and/or attribute values which are already in these tables but which have changed. During this process, all devices and elements get their snapshot ID column updated so that the appropriate bit for this global scan is set to some value which indicates if the asset was discovered during this particular fuzzy snapshot. This allows later analysis and/or reporting for queries such as which assets went offline between snapshots 1 and 2 or which software elements were installed between snapshots 3 and 4.

Step 56 represents the process of updating the indirect containment table 92 in FIG. 3. The indirect containment table maps which elements are installed on which devices. Step 56 therefore checks the indirect containment relationships already in the ind_containment table 92 in FIG. 3 and determines if the new matches on devices and elements indicate any containment relationship has changed. If so, the entries in the ind_containment table are changed appropriately.

### FIG. 3

FIG. 3 is a diagram illustrating the data structure and processes of the persistent data warehouse object 78 and illustrating the data flows indicating how local scan attribute data is merged into the persistent data warehouse schema. FIG. 3 essentially represents in graphical detail the process of FIG. 2 symbolized by steps 26 and 28 in FIG. 1B. Arrows 58, 60 and 62 represent the local scan schema data being imported into the persistent data warehouse object 78. The local scan database schema is represented by block 64 and contains a transactional store 66 and a base table and an indirect containment table. In the preferred embodiment, the base table and indirect containment table are structured in the same format as these same tables exist in the persistent data warehouse. The base table and indirect containment tables 68 in the local scan schema 64 are a list of all the assets discovered on the local scan and the attributes of each asset. The indirect containment table show the containment relationships, i.e., which elements are installed on which devices.

Arrow 70 represents the process of steps 22 and 24 in FIG. 1A wherein the transactional raw data collected in the local scans is converted to the data format and type and the table format used in the persistent data warehouse 78. In some alternative embodiments, the process represented by arrow 70 can be omitted and the transactional store data 66 (the raw data) can be imported directly into data structure 34B. In that embodiment, the transactional data would have to be organized into the device table 82, the base table 84 and the ind_containment table 86 of data structure 34B before the device and element matching processes started.

Block 72 represents the process of step 44 in FIG. 2 of IDSpace and NameSpace allocation and arrow 76 represent the process of importing the base table, device table and ind_containment tables from the local scan schema 64 into the local scan data warehouse object 80. Arrow 76 represents the process of building a local scan device table 82 using the local scan attribute data. The local scan data in table 68 is already organized by virtue of the individual containment table into which attributes are associated with which devices. The device matching process 94 functions to determine using the weighted matching rules which of these devices in the local scan device table 82 are the same devices as are in the persistent global device table 88 and to update a mapping table (not shown).

Arrow 74 represents the process of assigning unique names to each imported local scan table so that local scan data from each scan can be kept in its own unique namespace which is the process of block 46 in FIG. 2. Both the local scan data warehouse 80 and the persistent data warehouse 78 are objects in the object oriented programming sense in this each has both a data schema represented by the various tables discussed below and they may have processes that can be invoked such as processes 94, 96 and 98 discussed below.

Arrow 76 essentially represents the data flow that results from the processing of steps 26 and 28 in FIG. 1B. Arrow 74 represents the process of assigning unique names to each imported local scan table so that local scan data from each scan can be kept in its own unique namespace and is the data flow which results from the process of block 46 in FIG. 2. The individual namespace for the imported local scan data is represented by block 34B (part of the data warehouse schema 34 in FIG. 1B) where local scan data is initially stored). The local scan namespace contains a device table 82, a base table 84 and an individual containment table 86. The local scan device table 82 has the same structure and purpose as the persistent device table 88. The local scan base table 84 has the same structure and purpose as the persistent base table 90. The local scan indirect containment table 86 has the same structure and purpose as the persistent indirect containment table 92. The data from these tables needs to be merged into the corresponding tables in the persistent data warehouse by the matching process (merging meaning updating the persistent table with newly discovered attributes and obsolete values with new attribute values discovered in subsequent local scans). Those persistent data warehouse tables are persistent global device table 88 (referred to earlier herein as the persistent device table and which is based upon the persistent asset IDs), the persistent global base table 90 which also is based upon the persistent asset_IDs, and the persistent global ind_containment table 92 which also is based upon the persistent asset IDs. Persistent asset IDs are needed in the persistent data warehouse to uniquely identify each discovered asset.

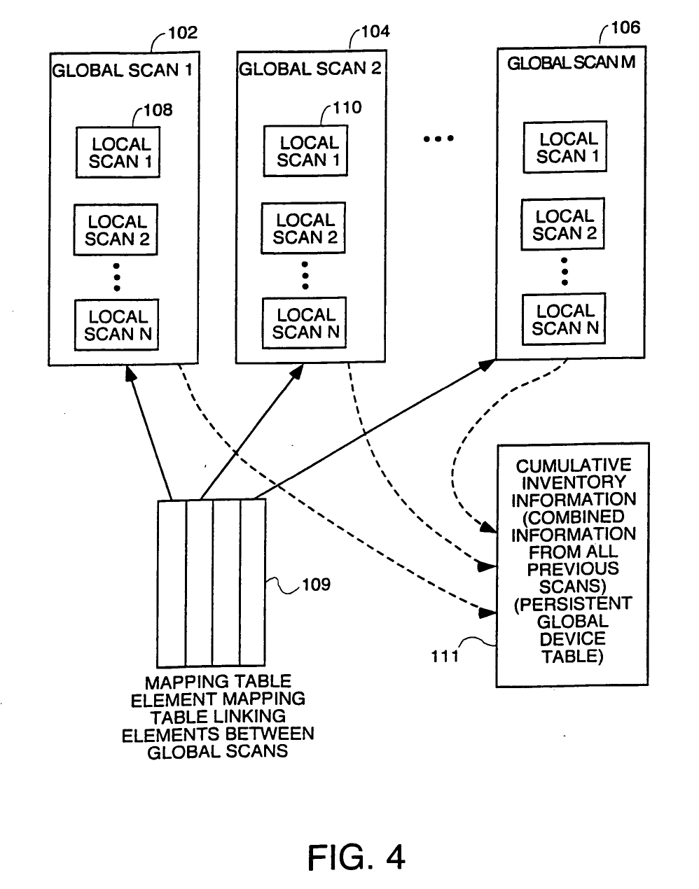

Block 94 is the device matching process, and represents the process of step 48 in FIG. 2 and step 100 in FIG. 1B of running the device matching algorithm using the attribute data from the local device table 82 and the persistent global device table 88 to map device IDs that match between these two input tables. The device matching algorithm of FIG. 94 uses the weighted attribute matching process represented by FIGS. 5 and 6 using intermediate results and an ever more complete set of attributes in the Persistent Global Device Table 88 to do the matching. Essentially, the device matching algorithm 94 uses attribute data and weighted matching rules to look for matches between devices having persistent_element_IDs in the persistent global device table 88 and devices having local scan element_IDs from the local device table 82. Any device matching process that uses weighted attributes to compare local scan collected attributes against the attributes of devices already found on previous scans will suffice to practice the invention.

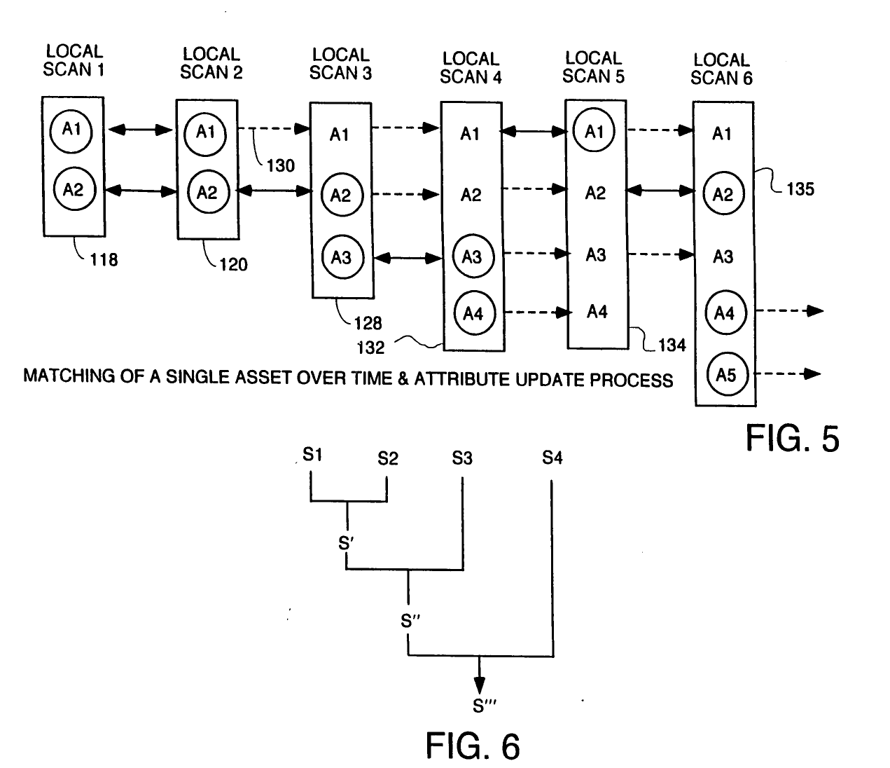

However, the preferred embodiment uses a device matching process that matches using the highest weighted attributes first and eliminates any matches found and then proceeds to try to find matches among the remaining devices based upon lower weighted attributes. FIG. 7 is a flowchart that illustrates this process generally. Step 136 represents the process of selecting the highest weighted attribute or combination of attributes and performing matching on all devices in the local scan for which this attribute or combination of attributes were collected. In other words, for every device in the local scan for which the highest weighted attribute or combination of attributes were found, matches on this attribute or set of attributes will be searched for in the devices currently in the Persistent Global Device Table.

Step 137 represents the process of removing from the local scan device table 82 all devices for which matches have been found. In some embodiments, the matching devices are removed from both the Persistent Global Device Table 88 and the local scan device table 82 in step 137. In other embodiments, the matching devices in both tables 82 and 88 are simply marked as matched and ignored on subsequent iterations.

In step 138, the next highest weighted attribute or collection of attributes are selected and matching is performed on devices in the local scan table for which that attribute or collection of attributes have been collected. Step 140 determines if all local scan devices have been processed. If not, processing is vectored back to step 137 to remove the devices for which matches have been found from the local scan device table 82, and then step 138 is performed again to pick the next highest weighted attribute or set of attributes and do matching again on the devices in the local scan device table 82 for which that attribute or set of attributes have been collected. If step 140 determines that all devices for which attributes have been collected in local scan device table 82 have been processed, then step 142 is performed to update the data in the persistent data warehouse tables. If a device has been found for which no matches were found, it is added to the Persistent Global Base Table and the Persistent Global Device Table 88 (or the Persistent Global Device Table is re-generated from the updated Persistent Global Base Table) and the mapping table is updated. Any new attributes collected for devices already in the Persistent Global Device Table 88 that are not in the Persistent Global Device Table and the Persistent Global Base Table are added to those tables in any way.

This process of matching first on higher weighted attributes before moving to lower weighted attributes is more efficient and the process tends to go faster as it goes along since many devices have already been eliminated from the pool of attribute data from the local scan device table being processed.

After all the devices in the local scan have been matched to devices in the Persistent Global Device Table 88 or it has been concluded that a device in the local scan is new and it is added to the Persistent Global Device Table 88, processing of the local scan data is complete. At this point any devices that were removed from the Persistent Global Device Table 88 after having been matched are put back in table 88. In embodiments where the matched devices are not removed but are marked in the Persistent Global Device Table 88 as matched, any devices in Persistent Global Device Table 88 marked as already matched are unmarked. This processing readies the Persistent Global Device Table 88 for further processing of new local scan data. Note that since any newly discovered attribute data about a device in the Persistent Global Device Table 88 is added to the collection of attributes about that device, on the next local scan device matching round of iterations the attribute data received from the Persistent Global Device Table 88 will be “intermediate result” data which includes all the attributes discovered up to this point in time for each particular device. This means the matching process will get better and more efficient as time goes by and the collection of attributes about each device in the Persistent Global Device Table 88 gets more complete.

Returning to the consideration of FIG. 3, block 96 represents element matching logic, and represents the processing of block 112 in FIG. 1B. This is a process that examines the element_IDs from the local scan base table 84 and the persistent global base table 90 and maps all element IDs that match using weighting rules. The persistent global base table 90 contains all the attributes of all hardware and software assets found on any scan to date. In other words, it contains all the attributes for everything used by an entity—both hardware devices and any software installed on them. The persistent global base table 92 is then updated with any new values for attributes or newly discovered attributes about an element for which a match was found by the element ID matching logic process using the weighted attribute matching rules so as to add newly found elements and attributes from the local scan to the persistent global base table 90 to make it more complete. This is the process represented by step 52 in FIG. 2. The global base table is a table that lists all assets discovered to date and their attributes. The device attributes in the persistent global device table 88 are taken out of the base table 90 in the preferred embodiment.

The persistent ind_containment table 92 (a table that shows which elements are installed on which devices) is then updated using the local scan ind_containment table 86 by mapping element IDs to the persistent device IDs in the persistent ind_containment table upon which those elements are installed, as represented by arrows 94 and 95 and process 98 which represents the processing of step 56 in FIG. 2. This updates the containment relationships indicated in the persistent ind_containment table 92 to add newly discovered elements that are contained within other larger systems such as servers, etc. or any containment relationships which have changed. The indirect containment table is not necessary in all embodiments. It is present in the preferred embodiment because it speeds up any computation related to containment. In alternative embodiments, the indirect containment table is structured like a family tree.

### Example of Device and Element Matching Processes Using Persistent Data Warehouse

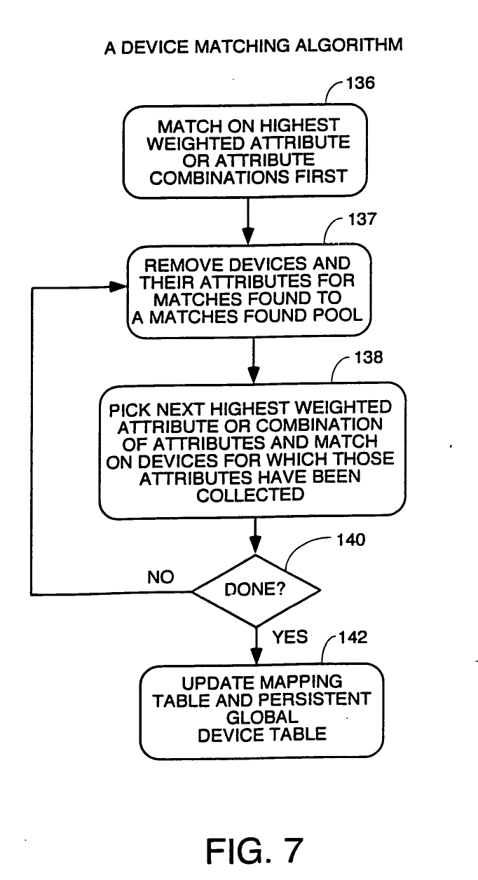

FIG. 8 is an example of a device and element matching process using the local scan tables of attributes and the persistent global data warehouse tables of attributes. Persistent global base table 90 contain all device and element attributes accumulated from all previous scans about every device and element for which attribute data has been collected. Local scan base table 68 contains the attributes of all devices and element collected during a subsequent scan. Tables 90 and 68 each contain the attribute data of a particular server computer called Windows 2000 server represented by block 67 in the global persistent base table 90 and assigned ID 1001 therein, and also represented by by block 67′ in the incoming base table from the most recent local scan where it as assigned local scan ID 2002. It is the function of the device matching logic 94 to use the attributes to determine that the device assigned local scan ID 2002 is the same device as the device in the Global Persistent Base Table 90 assigned to ID 1001.

To do the device matching, the matching system extracts device attributes for each device whose attributes are stored in the Global Persistent Base Table 90. Line 150 represents this extraction process. This extraction process generates the Persistent Global Device Table 88. Line 152 represents the same process of extracting the device attributes for all the devices from which attributes were collected. This extraction is done from the local scan table 68 and generates table 82. Device matching logic uses weighted extensible attribute matching rule set (which can be a module of rules called up for matching Windows 2000 servers or a general weighted rule set used for all matching but which is extensible in that rules can be added or deleted at will). The weighted attribute matching rule set is used by the device matching logic 94 to compare device attributes in local scan device table 82 collected in the local scan against and makes matches using the highest weighted attributes first and then proceeding to continue attempting to match devices in the local scan to devices in table 88 based upon lower weighted attributes. This process finds a match between ID 1001 and local ID 2002 so device matching logic 94 maps the device ID 2002 from the local scan represented by 67′ to the device ID 1001 for the same device in table 88. This mapping information is entered in mapping table 109 in FIG. 4 which is also shown as part of the device mapping logic 94 in FIG. 3. This can be done as each match is found or as a batch after all matches have been found. The mapping table 109 maps devices and elements that are the same from different global scans. FIG. 11 is an example of a data structure for the mapping table to map IDs in the Global Data Warehouse to the IDs in the local scans which are part of periodic global scans.

As each device match is found, the attribute data for that device and the device entry itself in the persistent global device table 88 are either temporarily removed (to be replaced later after all matching is finished) or marked as already matched. This reduces the amount of device attribute data which needs to be searched as the process proceeds so the process can go faster.

Line 122 represents the update process to update the attribute data for this device in the table 88 if new attribute data is found in the local scan for the device having ID 1001 in the Persistent Global Device Table 88. This device matching process is the fallout from elimination of agent-based discovery. If agent-based discovery had been performed, the ID in the local scan would have been the same as the ID for the same device in the Persistent Global Base Table 90.

Once the mapping between devices is known between the PDW device table entries in table 88 and the local scan device table 82 and the containment relationships between the devices and their elements in the PDW base table 90, comparisons of element attributes in local scans to element attributes in the PDW base table 90 can begin. Determining the device matches first and the containment relationships of each device makes the element matching process much easier and faster.

Arrow 156 represents the portion of the element matching process of extracting the element attributes for each device from the persistent global base table 88, the attribute data for elements installed on the Windows 2000 server ID 1001 being represented by block 157. Each line in block 157 represents the attributes of a particular element such as an application program such as Office 98 installed on Windows 2000 server ID 1001. The containment relationship data in table 92 of FIG. 3 is used to parse out the element attribute data for each device in the GDW. Arrow 158 represents the process of extracting the element attribute data collected on the most recent scan for all elements from the local scan base table 68. The containment relationship data in table 86 in FIG. 3 is used to parse out the attribute data for each device in the local scan. That attribute data is represented by block 159. Then element matching logic 96 then uses weighted rule set 154 to match elements from the local scan to elements in the persistent data warehouse using attributes only. The weighted rule set can be a fixed set of extensible attribute weighting rules such that the same file of rules is always read, but rules can be added or deleted from the file. Another embodiment is to call up a set of weighted attribute matching rules based upon the type of device or element whose attributes are being examined for a match. In this embodiment, block 154 represents a module of special rules tuned for matching devices or elements installed thereon such as hardware peripherals or expansion card or installed software applications as the case may be. This module can be installed on or read by the particular type of computer on which matching is being as needed by the matching demands on the system.

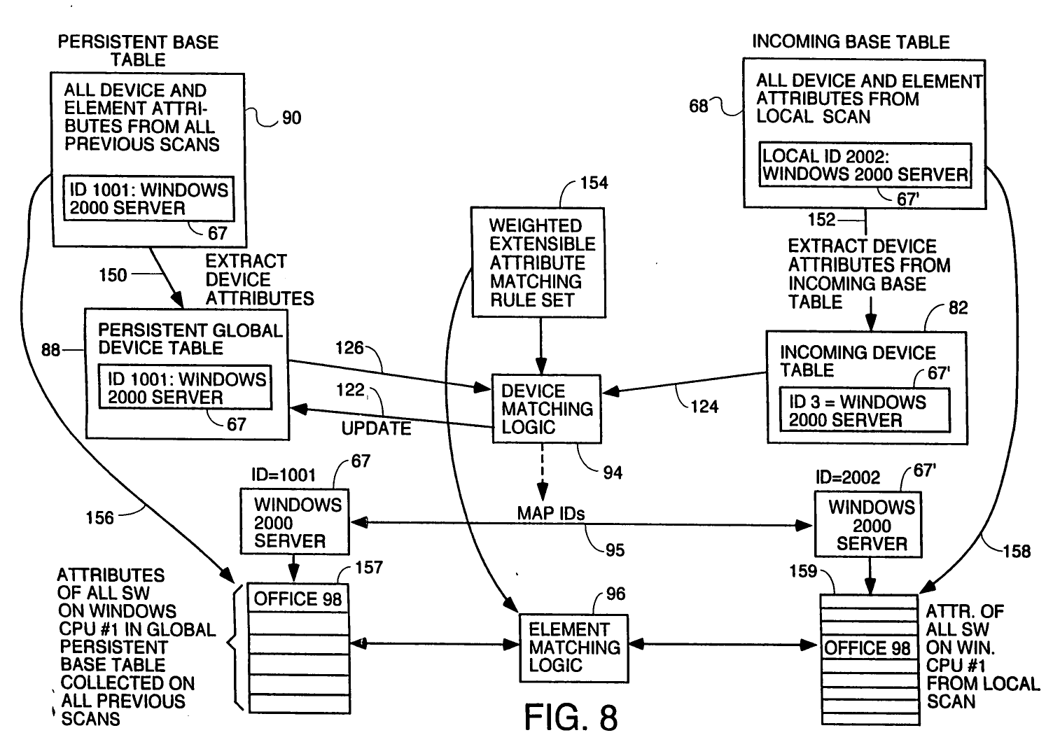

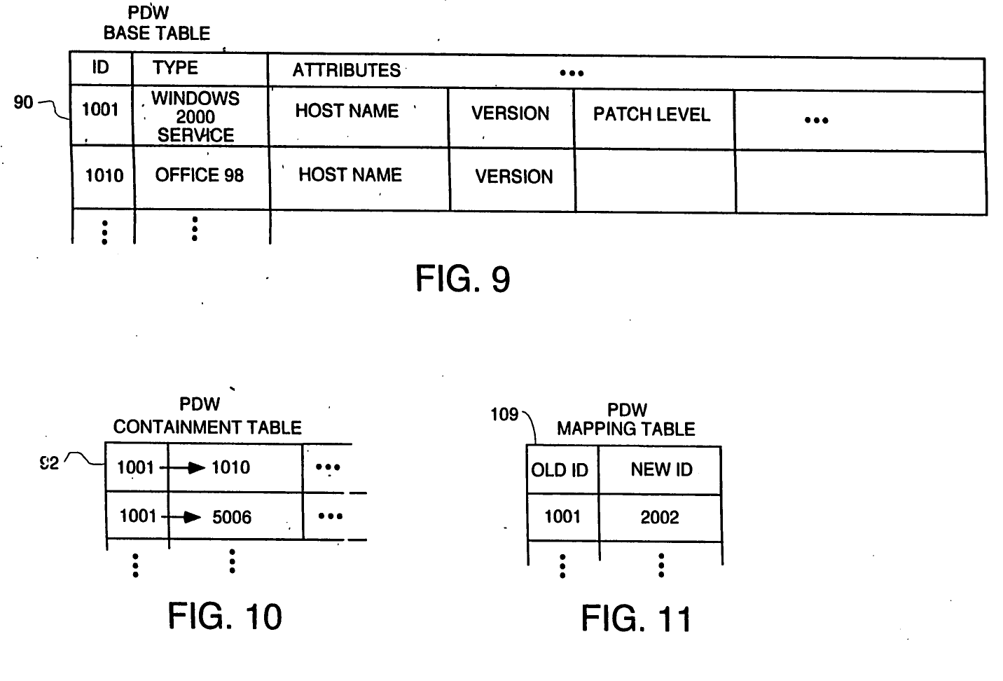

FIG. 9 is an example of one type of global persistent base table data structure. ID 1001 has been assigned to a Windows 2000 server which has various attributes such as host name, version, patch level etc. ID 1010 has been assigned to a software application Office 98 which is installed on the Windows 2000 server given ID 1001. It has attributes host name and version. FIG. 10 is an example of the data structure of the Persistent Global Ind-containment Table 92 in FIG. 3. Its first row indicates that the element having ID 1010 is installed on the device having ID 1001. The IDs in the containment table are the mapping between the entries in the containment table and entries in the base table. There is a separate base table, device table and containment table in the Persistent Data Warehouse (34A in FIG. 3) and in each global scan comprised of one or more local scans (34B in FIG. 3).

One desirable result of matching based upon weighted attributes is that confidence metrics can be developed. For example, if a match is based upon a match in attributes weighted eight and another match in attributes weighted four, the confidence metric that the match is a good one is twelve. This is very important in being able to satisfy customers that the quality of the inventory results and other reports is high. Any quality metric formula based upon the weights of the attribute matches that caused the conclusion that a device or element in the global persistent base table and a device or element in the local scan data are the same device or element will suffice to practice this aspect of the invention.

### FIG. 4

Steps 34 and 100 in FIG. 1B can best be understood by reference to FIG. 4 which is a diagram of the data warehouse data structure which is established as an empty data schema in step 11 of FIG. 1A. FIG. 4 shows the tables of the data warehouse which gets populated as the local and global scans are performed and has arrows which represent the various matching processes of the flowcharts of FIGS. 1, 2 and 3 which are performed to match devices and elements between global scans. Blocks 102, 104 and 106 represent the separate address/name spaces in the persistent data warehouse of multiple global scans. Each global scan has within its address space/name space separate name spaces for each of the one or more local scans which together comprise the global scan. A global scan is executed by running several local scans, possibly at different times. The user specifies which local scans comprise a global scan. Each local scan is typically a table within the global scan table or a table which has a pointer to it in the global scan table. Each local scan table typically contains metadata which identifies the date, source and region of the local scan so that time-based reports can be generated. Time-based asset comparison reports can then be generated using the timestamp data so that changes in the entire inventory of the entity over some user-specified time can be generated as well as time-based reports of changes in some user-specified asset (or assets) over some user-specified time.

Global scans are typically done on a periodic basis such as every month. Each global scan represents the state of inventory of the entire enterprise at one particular “moment in time”. Actually the “moment in time” of each global scan is not an exact moment in time but is what will be referred to herein as a “fuzzy snapshot”. A fuzzy snapshot allows time-based reports to be generated.

The basic idea underlying the fuzzy snapshot is to collect local scan data from different geographical regions, different parts of an enterprise, different collection data sources and different times into one “window” of time designated as the “time” of the combined report. So a fuzzy snapshot can encompass local scans taken at different times, different areas of the company, etc. but all within the predefined window of time for which a time-based report is valid. Another way of thinking about a fuzzy snapshot is that if the asset data is thought of as a three-dimensional space with its axes being time, region and source, a “fuzzy snapshot” encompasses a region of that space, typically a rectangular box that spans all sources, all or some regions and a range of time. Historical timelines of these fuzzy snapshots can be created as can timelines for individual assets. Each global scan is assigned a unique snapshot ID.

Each local scan is one of the local scans represented by arrows 58, 60 and 62 in FIG. 3 and by the line of steps starting with steps 12 and 14 in FIG. 1A. Each of the local scans, such as 108 and 110 in FIG. 4, represents the imported transaction data from a particular local scan which has been formatted into the data types and table format such as the device table (88 in FIG. 3), base table (90 in FIG. 3) and ind_containment table (92 in FIG. 3) used in the persistent data warehouse.

The elements in the global scans are related by a mapping table 109 which contains data which maps elements in one global scan to the same element in all other global scans. Each time a new element is found, that element is added to a cumulative inventory table 111. This table stores the combined information from all previous scans and is represented by the three tables 88, 90 and 92 in FIG. 3 withing dashed line 34A. Each global scan such as 102 in FIG. 4 is comprised of one or more local scans, each of these local scans being comprised of the three tables 82, 84 and 86 in box 34B in FIG. 3.

On each device there may be software applications installed which also need to be inventoried. This is the function of block 112 in FIG. 1B. The process symbolized by block 112 is the element matching process. This process uses an extensible set of weighting rules to match incoming inventory attribute data with persistent inventory attribute data in the data warehouse. The process of block 112 finds out which elements such as software applications are installed on each device. Performing the device matching process of block 100 first followed by performing the element matching process of block 112 second is preferred because if software matching is done first, the most important attribute about the software, i.e., on which device it is installed, is missing. If this attribute about a piece of software is missing, it is difficult to distinguish how many different copies of that software exist in an entity. Knowing on which device each piece of software is installed makes it possible to better distinguish and accurately count the number of software titles that are owned or leased by an enterprise.

After the device and element matching processes of blocks 100 and 112 are completed to find matches between the same devices and elements that show up in different global scans, the devices and elements are “merged”. This means that entries are made in the mapping table 109 in FIG. 4 to show the correspondence of devices and elements between different global scans. Also the cumulative inventory information table 111 is updated if a device or element on the device has not yet been entered therein. Typically, the cumulative inventory table 111 is instantiated with all the attribute data that is returned by the first global scan. In subsequent global scans, the matching process happens and matches are recorded in the mapping table to show the correspondence between the same devices in different global scans. The cumulative inventory table is then inspected to determine if any of the attributes returned in the new global scan for devices or elements already in table 111 have not been previously recorded in table 111. If so, these attributes are added to the appropriate fields of the record of the device or element with which the attribute is associated, as symbolized by block 114 in FIG. 1C. Thus, the cumulative inventory table becomes more and more complete over time as new global scans are performed.

The global scan data has timestamp data indicating when each global scan was completed. This allows fuzzy snapshot reports to be created where one of the criteria for inclusion of an element or device in the report is did it show up in a global scan taken between certain dates that define the time interval of the fuzzy snapshot. Also, cumulative inventory reports can be done from table 111 to show all devices and elements the entity has ever had. Likewise, current inventory reports can also be performed to determine from the data warehouse data all devices or elements which have showed up in any global scan within a recent interval. In embodiments where assets are automatically removed from the data warehouse if they have not showed up in some predetermined number of recent global scans, then the current inventory report can be run with no time restriction and without the need to check the timestamp data. The generation of these various reports is symbolized by block 116.

### FIG. 5

FIG. 5 is a diagram that illustrates more detail about how the device matching process 94 in FIG. 2 works and how attributes from local scans are accumulated and the device table attribute collection is rendered ever more complete as new attributes are found in successive local scans. What FIG. 5 represents is the process to first match an asset whose attributes were returned in a second local scan to the same asset whose attributes were returned in a first local scan, and then associate newly found attributes for the same asset returned in subsequent local scans with that asset and update the collection of attributes for that asset to render the collection ever more complete. The process of FIG. 5 makes the collection of attributes about any particular asset more complete over time. This has at least two advantages. First, matching becomes more accurate and efficient to avoid double counting of the same asset. This is because matches using partial attributes data (attribute data that was not returned in earlier local scans) returned by subsequent local scans are made possible because the collection of attribute data in the persistent global data warehouse base table becomes ever more complete. The device table is updated with newly attribute data for a device every time new attribute data is found. The process is represented by line 122 in FIG. 3. Because the device table collection of attributes about each device becomes ever more complete, the device matching process 94 in FIG. 3 becomes ever more efficient and accurate. That means is a local scan comes in which has only a partial set of attributes or different attributes than were returned in earlier local scans and one or more attribute from the partial set of attributes is in the persistent device table 88 in FIG. 3, then a match on that device is more likely to be found so that the device is less likely to be counted twice. Because the device matching becomes ever more accurate, the element matching process which follows it becomes ever more complete. The attribute updating process of FIG. 5 is not limited just to updating the collection of attributes in the persistent device table with newly discovered attributes. The process of FIG. 5 is applicable to all assets, so it also updates the persistent base table 90 in FIG. 3 with newly found attributes about elements. That updating process is represented by line 91 in FIG. 3.

Another advantage of the process of FIG. 5 is that as the attribute collection about each device becomes ever more complete, the reports generated about any particular asset can be ever more rich and detailed.

Box 118 represents local scan 1 which is the oldest and first scan in time and returned attributes A1 and A2. Because the persistent base table and persistent device table are empty at this time, those attributes are added to the base table or the device table by either the update process represented by line 91 or the process represented by line 122 in FIG. 3, depending upon whether the asset was a device or an element. “Persistent” as that term is used here to modify some named data structure means the named data structure is in the persistent global data warehouse.

Box 120 in FIG. 5, represents local scan 2 which is the next local scan in time and which also returned attributes A1 and A2. Assume A1 is the serial number of the motherboard or some similarly important attribute and is the most heavily weighted. Assuming local scan 1 is the first local scan, its attribute values will be written into the Persistent Global Device Table 88 in FIG. 3 by the device mapping process 94 automatically since there is no other local scan to compare this attribute data to, as symbolized by arrow 122.

For simplicity and clarity in explanation of the concept, it is assumed that each local scan in FIG. 5 returns only attributes of one asset and each local scan returns attributes of the same asset. Referring jointly to FIGS. 5 and 3, when local scan 2 arrives in local scan data structure 34B, attributes A1 and A2 of the same asset which returned attributes in local scan 1 will be compared to the attributes in persistent device table 88. This process is represented by block 94 and lines 124 and 126. Actually line 126 represent access to all the attributes stored in the persistent device table 88 since at this point, it is unclear which device in the persistent device table corresponds to the device in local device table 82 whose attributes were returned in local scan 2. Since A1 is weighted so heavily, a match will be declared between the local scan element ID (the ID assigned to the asset that returned the attributes in local scan 2) and the persistent element ID in the Persistent Global Device Table 88 which is associated with the same asset. A mapping entry will then be made mapping that persistent element ID to the local scan element ID that returned the local scan 2 attribute data in FIG. 5. That mapping entry is stored in mapping table 109.

Next, local scan 3 attribute data 128 is returned about the same asset as returned the attribute data in local scans 1 and 2. Local scan 3 returned only attributes A2 and A3 about the asset. The device matching process 94 declares a match based upon the match of attribute A2 with the attribute data stored in the persistent device table about the asset. This matching process is represented by line 131. The device matching process then updates the attribute collection about this particular device by writing attribute A3 into the Persistent Global Device Table 88 via data path 122. Now the persistent element ID associated with the attribute data A1 and A2 in the Persistent Global Device Table 88 is also associated with attribute A3. This is how the attribute collection about this particular device becomes ever more complete. The same process occurs as to updating the base table if the asset returning the attribute data is an element and not a device. Dashed line 130 represents the fact that the device matching process sees that attribute A1 of the asset which returned data in local scan 2 is associated with with the same asset which returned attribute A2 in local scan 3 upon which the match was declared. As a result, the device matching process writes attribute A3 returned in local scan 3 into the collection of attributes for this asset in the Persistent Global Device Table 88.

Also, dashed line 130 represents the fact that new local scan data is compared to intermediate results which are amalgamations of attributes found on previous scans which are associated with an element ID in the Persistent Global Device Table 88. In other words, each asset's attributes returned in a local scan get compared to all the attributes for that same asset in the persistent device table (as well as all the attributes collected previously for all other devices which are in the persistent device table). FIG. 6 illustrates this concept. FIG. 6 shows how the result of the comparison of attribute data from scan S1 (118) and scan S2 (120) results in an intermediate result represented by S′ in the Persistent Global Device Table 88 and illustrates how the latest scan is always compared to an intermediate result consisting of the amalgamation of all the attributes found for that particular asset in all previous scans. In other words, old attributes from previous scans are carried forward in the matching process to fill in the gaps so that the newest scan is matched against the most complete collection of attributes available for that particular asset. Thus, when local scan 3 (128) arrives, its attribute data (A2 and A3) is compared to the amalgamation of attribute data A1 and A2 in the Persistent Global Device Table 88 and a match is found on A2. This causes the device matching process to create a new intermediate result S″ (a new amalgamation of attribute data) in the Persistent Global Device Table 88 by adding A3 to the list of attributes associated with persistent device table asset with which A1 and A2 are associated.

Next local scan 4 arrives, and it returns only attributes A3 and A4 for the same asset that returned attribute data in local scans 1-3. These attributes are compared to the amalgamation of attributes A1, A2 and A3 for this asset in the persistent device table (represented by block 132), and a match is found on A3. This causes attribute A4 to be added to the amalgamation of attributes associated with this asset in the Persistent Global Device Table 88 via data path 122.

Next, local scan 5 arrives and only attribute A1 is present. This local scan is compared to the amalgamation of attributes in the Persistent Global Device Table 88 for the same asset of local scans 1-4. At this point this amalgamation of attribute data is attributes A1 through A4 (represented by block 134). A match is found on A1, so no updating of the attribute data in the table 88 is performed.

Finally, local scan 6, represented by box 135, arrives and returns attributes of the same asset which returned attributes in scans 1-5. Local scan 6 returns attribute A2, new attribute A5, and attribute A4 which has a new value since something about the asset has changed since local scan 5. The device matching process declares a match based upon A2 because that is a higher weighted attribute than A4 and because the persistent device table has no current information about A5. The result is that attributes A1 and A3 are carried forward (which means it is left as is in the persistent device table), the value of attribute A4 in the persistent device table is updated to the new value, and attribute A5 is written into the collection of attributes about this asset in the persistent device table to make the collection more complete.

A parallel process occurs for elements, and the actual process occurs for all assets which returned attributes in a local scan and not just one asset as used in the example.

The matching rules have weighting which is based not only on individual attributes having individual weights but also combinations of attributes being weighted also. Usually the combinations of attributes are weighted more heavily than any individual attribute. For example attribute A2 may have an individual weight of 4 while a combination of attributes A1 and A2 will have a weight of 16, for example. Thus, if combinations of attributes are found in a local scan collection of attributes and these combinations have heavy weighting and match combinations of the same attributes in the Persistent Global Device Table 88 for some persistent element ID, then a match between the local scan element ID which returned the combination and the persistent element ID is highly likely to be declared.

1.-27. (canceled)

28. A process for matching devices and elements installed on said devices based upon their attributes comprising the steps:
A) using a computer to initially collect attribute data about each of a plurality of devices used by an entity and elements installed on said devices;
B) establishing a persistent global base table which stores all the attribute data discovered about all devices and all elements installed on said devices and storing all the attributes discovered in step A about each device and each element installed thereon in said persistent global base table;
C) establishing a persistent global device table and extracting at least some of said attribute data discovered in step A about each device from said persistent global base table and storing said extracted attribute data in said persistent global device table;
D) using a computer to do a local scan to discover attributes about at least some devices used by an entity and elements installed thereon and storing said attribute data in said local scan base table;
E) establishing a local scan base table and storing attribute data discovered in step D in said local scan base table and establishing a local scan device table by extracting at least some of said attribute data discovered in step D from said local scan base table and storing said extracted attribute data in said local scan device table;
F) performing a device matching process by comparing said attribute data discovered in step D and stored in said local scan device table in step E against attribute data stored in said persistent global device table, said comparison done using weighted attribute matching rules wherein matches between predetermined attributes are weighted more heavily than others, said comparison attempting to determine which devices for which attributes were discovered in said step D are the same devices having attribute data discovered in previous local scans and which is stored in said persistent global device table.

29. The process of claim 28 further comprising the step:
G) when one or more attributes about a device is discovered in the scan performed in step D which are not in said persistent global base table or which have values which have changed from the values recorded in the persistent global data warehouse for that attribute, updating the collection of attributes associated with said device upon which said match was found in said persistent global data warehouse data structure with any newly discovered attributes or any attribute data which has changed;
and wherein step F is performed by comparing the attributes found in said scan performed in step D to the complete set of attributes found on all previous scans for each device in said persistent global device table.

30. The process of claim 28 further comprising the steps:
G) performing an element matching process by comparing attribute data discovered in step D and stored in said local base table to attribute data stored in said persistent global base table using weighted attribute matching rules;
H) when one or more attributes about a device or element installed on a device is discovered in the scan performed in step D which are not in said persistent global data warehouse or which have values which have changed from the values recorded in the persistent global data warehouse for that attribute, updating the collection of attributes associated with said device or element in said persistent global data warehouse data structure with any newly discovered attributes or any attribute data which has changed;
and wherein steps F and G are performed by comparing the attributes found in the local scan of step D to the complete set of attributes found on all previous scans for each device in said persistent global data warehouse, and, if a match is found, marking as already matched in said local scan data warehouse and said persistent global data warehouse or temporarily removing therefrom to a matches found database said elements and devices for which matches have been found such that the pool of attribute data in said global scan data warehouse which is being searched for matches against attribute data found in said local scan of step D becomes smaller as matches are found.

31.-54. (canceled)

55. A process comprising:
A) using a computer executing an automated asset inventory system to take automated discovery of assets of an entity without the use of agent programs installed on the discovered assets, said discovery taken in multiple scans over time, each scan returning data regarding one or more attributes of each discovered asset;
B) comparing said data of one or more attributes of each discovered asset in the most recent scan to data of one or more attributes of assets discovered in previous scans and using an extensible set of attribute weighting rules to determine which asset(s) in the most recent scan are the same asset(s) as were discovered in one or more previous scans.

56. The process of claim 55 further comprising the step of adding attribute data discovered about an asset in the most recent scan to the appropriate entry and the appropriate attribute field of an entry for said asset in a data warehouse data structure which includes data regarding multiple attributes of each asset that has been discovered in one or more scans.

57. The process of claim 56 further comprising the step of assimilating into said data warehouse data structure attribute data discovered about one or more assets of said entity by another agent-based or agent-free automated inventory discovery system after suitable conversion, if necessary, of said attribute data into the proper format for inclusion in the appropriate asset entry and the appropriate field of said asset entry of said data warehouse data structure.

58. The process of claim 55 further comprising the step of adding attribute data discovered about each asset in any scan to an entry created for said asset in a data warehouse data structure such that said data warehouse data structure includes an entry and attribute data for each asset ever discovered on any scan.

59. The process of claim 55 further comprising the step of adding attribute data discovered about each asset in any scan to an entry created for said asset in a data warehouse data structure and including a timestamp for attribute data added to said data warehouse such that said data warehouse data structure includes an entry and attribute data for each asset ever discovered on any scan, and further comprising the step of adding a timestamp to said data warehouse data structure associated with each asset entry when that asset entry is made so that changes in asset inventory over time can be tracked.

60. The process of claim 59 further comprising the step of assimilating into said data warehouse data structure attribute data discovered about one or more assets of said entity by another agent-based or agent-free automated inventory discovery system after suitable conversion, if necessary, of said attribute data into the proper format for inclusion in the appropriate asset entry and the appropriate field of said asset entry of said data warehouse data structure.

61. The process of claim 55 further comprising the step of adding attribute data discovered about each asset in any scan to an entry created for said asset in a data warehouse data structure such that said data warehouse data structure includes an entry and attribute data for each asset ever discovered on any scan, and further comprising the step of assimilating into said data warehouse data structure attribute data discovered about one or more assets of said entity by another agent-based or agent-free automated inventory discovery system after suitable conversion, if necessary, of said attribute data into the proper format for inclusion in the appropriate asset entry and the appropriate field of said asset entry of said data warehouse data structure, and wherein step B includes comparing attribute data discovered about assets from said other agent-based or agent-free automated inventory discovery system to attribute data discovered in step A by said automated agent-free asset inventory system and using attribute weighting rules to determine which assets discovered by from said other agent-based or agent-free automated inventory discovery system correspond to assets discovered by said automated asset inventory system.

62. The process of claim 55 wherein step B includes using an extensible set of weighting rules to do matching, and further comprising the step of adding weighting rules for matching on attributes when new types of assets are discovered, and wherein said weighting rules are such that host name and IP address count heavily in the matching process.

63. The process of claim 55 wherein step B includes the step of determining which of multiple types of assets an entity uses is the type of asset from which a set of attributes has been returned and then reacting by retrieving or accessing a set of weighting rules for attribute matching and using said weighting rules to match said set of attributes which has been returned against attributes of prospective matching assets gathered by previous scans.
